(19) United States
(12) Patent Application Publication
(10) Pub. No.: US 2015/0319549 A1
(43) Pub. Date: Nov. 5, 2015

(54) SOUND FIELD ADJUSTMENT FILTER, SOUND FIELD ADJUSTMENT APPARATUS AND SOUND FIELD ADJUSTMENT METHOD

(71) Applicant: CHIBA INSTITUTE OF TECHNOLOGY, Narashino-shi, Chiba (JP)

(72) Inventor: Hirofumi YANAGAWA, Chiba (JP)

(73) Assignee: Authentic International Corporation, Tokyo (JP)

(21) Appl. No.: 14/651,076

(22) PCT Filed: Dec. 24, 2013
(86) PCT No.: PCT/JP2013/084538

§ 371 Date: Jun. 10, 2015

(30) Foreign Application Priority Data
Dec. 25, 2012 (JP) 2012-281364

(51) Int. Cl. H04S 1/00; H04R 1/22

(52) U.S. Cl. CPC H04S 1/00; H04R 1/22

(57) ABSTRACT

A device for providing a sound field by adjusting the listener's interaural correlation coefficient. A sound field adjustment filter is provided with a pair of filter circuit groups corresponding to a left and right channel. This filter divides a desired frequency band of the audio signal into multiple frequency bands and assigns prescribed transmission characteristics to generate a sound field adjustment signal for each frequency band such that a prescribed impulse response is configured cooperatively for the entire desired frequency band of the audio signal. The transmission characteristics adjust the audio signal for each split frequency band by the addition of time delay and gain. By means of operation output units, the filter adds the sound field adjustment signals generated by each of the filter circuit groups to the audio signal of the other channels, and outputs to stereo speakers.

### TECHNICAL FIELD

The present invention relates to a sound field adjustment filter, sound field adjustment apparatus and sound field adjustment method to provide a good listening feeling to a sound field reproduced by stereo speakers by imparting particular sound field characteristics to acoustic signals.

### BACKGROUND OF THE ART

Conventionally, a sound field generating device is proposed to provide a reproduced sound field where a better spread feeling can be perceived by quantitatively representing the spread feeling of musical sounds using the interaural correlation coefficient of a listener (see the patent literature reference 1). This sound field generating device comprises, first and second processing circuits for carrying out a reverberation process of an input signal, a first filter for imparting a particular amplitude characteristic to the signal outputted from the first processing circuit, a second filter for imparting a particular amplitude characteristic to the signal outputted from the second processing circuit, a first adder for adding the signal outputted from the first processing circuit, the signal outputted from the first filter and the inverted output signal of the second filter, a second adder for adding the signal outputted from the second processing circuit and the signals outputted from the first and second filters, and wherein a first speaker is driven by the added signal outputted from the first adder, and a second speaker is driven by the added signal outputted from the second adder. The amplitude characteristic for each of the first and second filters is adjusted so as to approximate the frequency characteristic of the interaural correlation coefficient for narrow band stationary random signal to that of a diffuse sound field (reverberant room) to expand the sound image limited between left and right speakers.

### PRIOR ART DOCUMENTS

### Patent Documents

Patent Document 1: JP 08-130799

### DISCLOSURE OF THE INVENTION

### Problems to be Solved by the Invention

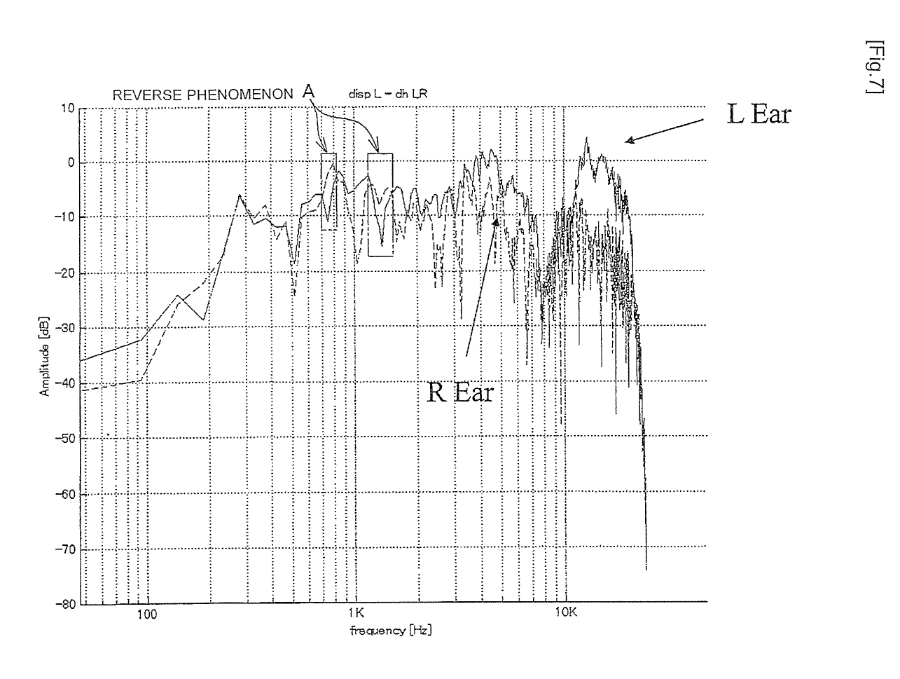

According to the conventional sound field generating device described above, the control of the interaural correlation coefficient is performed by a reflected sound generation circuit and a correlation coefficient control circuit. However, the obtained sound field and sound quality are deviated from the desired ones since the interaural correlation coefficient is adjusted after the reflected sound is separately added to the original sound. Further, the load of the hardware becomes large in order to approximate the interaural correlation coefficient to the diffuse sound field in the entire frequency band, so that it is difficult to provide the device at a low cost. In addition, in the case of a panel speaker provided with a common diaphragm, with regard to acoustic signals in the mid-high range frequency band, as shown in FIG. 7, there is a certain frequency range A where a reverse phenomenon that the sound pressure level outputted from one speaker of one of the channels based on the acoustic signal inputted to the one channel increases than the sound pressure level outputted from other speaker of other of the channels based on the acoustic signal inputted to the other channel occurs, thereby the sound field generated and outputted from the panel speaker is disturbed.

Accordingly, the object of the present invention is to provide a simple and economical device and method for processing sound wherein the interaural correlation coefficient of a listener can be easily approximated to the value corresponding to a sound field in accordance with a preference, and applied to a panel speaker.

### Means for Solving the Problems

In order to solve the above problems, the present invention provides a sound field adjustment filter 5 for adding sound field adjustment signals for imparting particular sound field characteristics to acoustic signals outputted to a pair of left and right stereo speakers 2, which comprises a pair of left and right filter circuit groups 5L, 5R for receiving left and right channel acoustic signals, respectively, dividing a predetermined frequency band of the acoustic signal into a plurality of frequency bands, adjusting a time delay and level of each divided frequency band such that a desired impulse responses is configured cooperatively for the entire frequency band of the acoustic signals to thereby generate the sound field adjustment signals corresponding to the left and right channels and respectively outputting to the other of the channels with each other. By adjusting the pass characteristic of each frequency band, a listener can perceive the virtual speakers 2, 2′ in which the opening angles thereof are changed with respect to a pair of speakers fixed in position, so that the interaural correlation coefficient is approximated for capable of perceiving a listening feeling in accordance with a preference of the listener.

With regard to a panel speaker 7 provided with a common diaphragm 7a, a pair of left and right separation filters 10L, 10R is provided, which, for acoustic signals in the mid-high range frequency hand, separate a particular frequency range A where the reverse phenomenon, that the sound pressure level outputted from one speaker 7 of one of the channels based on the acoustic signal inputted to the one channel increases than the sound pressure level outputted from other speaker 7 of other of the channels based on the acoustic signal inputted to the other channel, occurs and output to the other of the channels, and the filter circuit groups 5L, 5R generate sound field adjustment signals based on the acoustic signals outputted from the separation filters 10L, 10R.

Reduction filters 16L, 16R are provided for reducing the level of a particular frequency range A where the reverse phenomenon occurs, and the level of the pass characteristics assigned to the filter circuit groups 5L, 5R is adjusted so as to restore the frequency range A outputted to a low level.

Each of the filter circuit groups 5L, 5R has a plurality of filter circuits 50a, 50b . . . 50n. In order to adjust the pass characteristic, the filter circuits 50a, 50b . . . 50n have band pass filters 51a, 51b . . . 51n for dividing into a plurality of frequency bands, time delay setting means 52a, 52b . . . 52n for adding additional time delays for the divided frequency bands, and gain setting means 53a, 53b . . . 53n for adding predetermined additional gains for the divided frequency band, respectively.

The additional gain of the particular frequency range A in the reduction filters 16L, 16R is set to 1/k, i.e. the inverse of gain k of the particular frequency range A in the filter circuit groups 5L, 5R.

The sound filed adjustment device 1 using the sound field adjustment filter 5 is provided with the delay circuits 6L, 6R for adding the delay time required to generate the sound field adjustment signal to the acoustic signal, and operational output units 4L, 4R for adding the sound field adjustment signal to the acoustic signal and outputting the result to stereo speakers 2, 2.

### Effect of the Invention

In accordance with the present invention, the interaural correlation coefficient of the listener to the stereo speakers is easily adjusted only by changing the opening angle of the virtual speaker, and accordingly, it is possible to generate the diffuse sound field and further to approximate to the value for perceiving the sound field matched to a preference of the listener. Therefore, the load in hardware and software is small to thereby simple and economical device can be provided.

In addition, further effect is obtained that the adjustment is possible without the sound field being disturbed by the reverse phenomenon of the sound pressure level peculiar to the panel speaker provided with a common diaphragm for left and right channels.

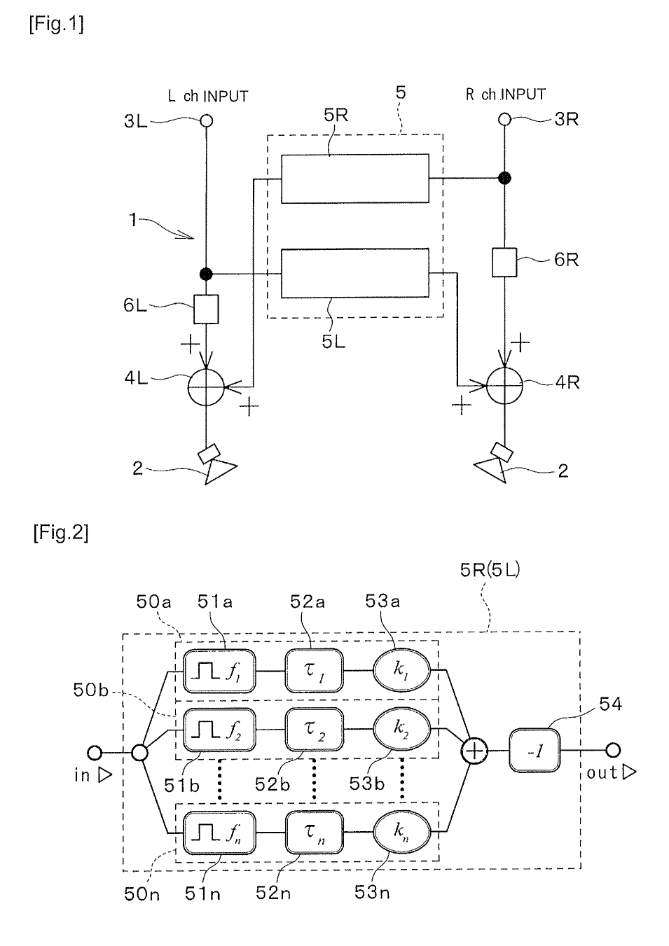

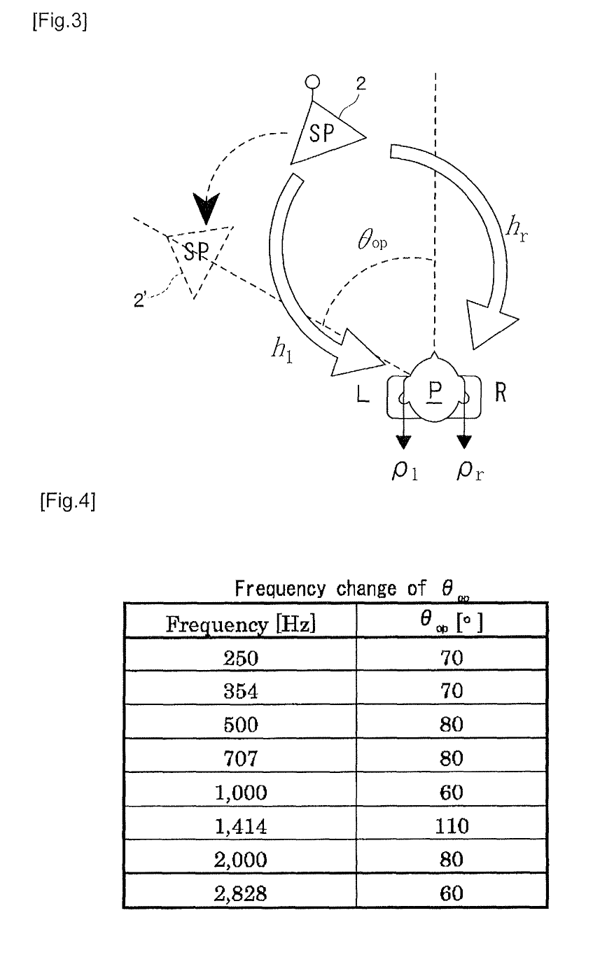

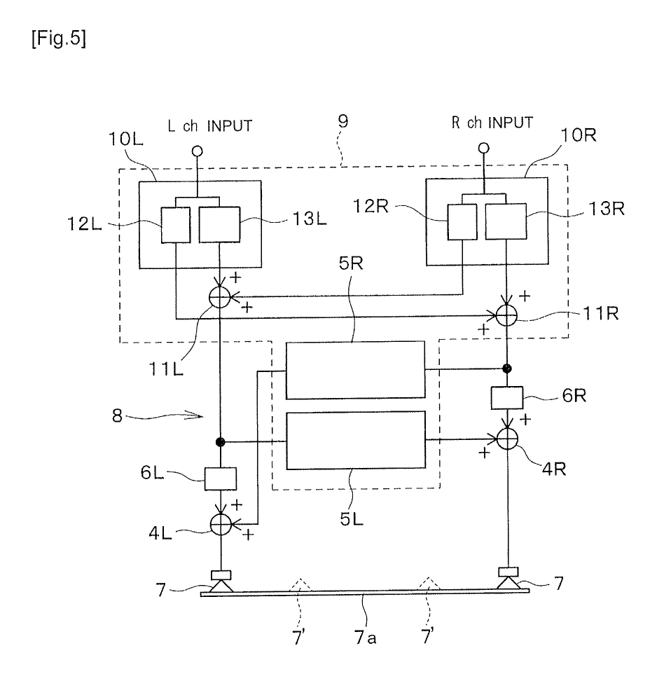

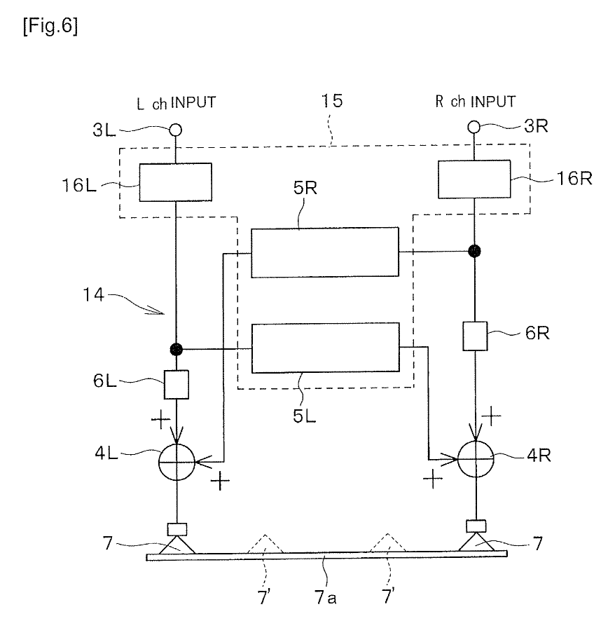

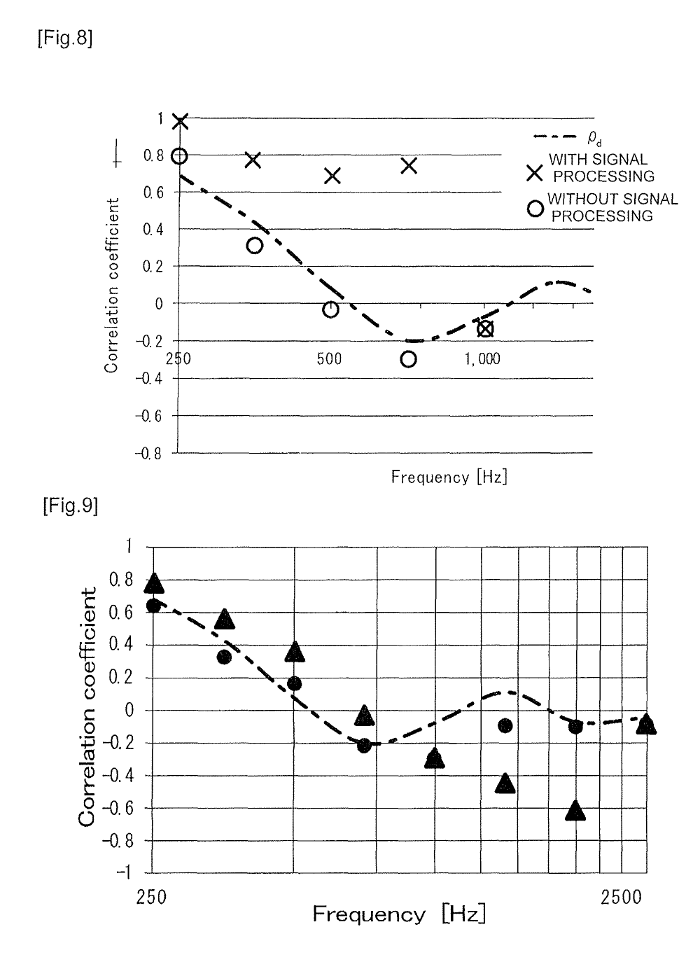

### BRIEF DESCRIPTION OF THE DRAWINGS

[FIG. 1] A block diagram of a sound field adjustment apparatus according to the present invention.

[FIG. 2] A conceptual diagram of a sound field adjustment filter.

[FIG. 3] An explanatory diagram of the sound field adjustment.

[FIG. 4] A correspondence table of an opening angle of a speaker with respect to the frequency.

[FIG. 5] A block diagram of a sound field adjustment device according to another embodiment.

[FIG. 6] A block diagram of a sound field adjustment device according to further embodiment.

[FIG. 7] A graph showing frequency characteristic of a panel speaker.

[FIG. 8] A graph showing changes in interaural correlation coefficient with respect to the frequency.

[FIG. 9] A graph comparing the presence and absence of a sound field adjustment signal processing with regard to changes of the interaural correlation coefficient with respect to the frequency.

### DETAILED DESCRIPTION OF THE INVENTION

An embodiment of the present invention is described hereinafter with reference to the drawings.

As shown in FIG. 1, a sound field adjustment device 1 for outputting acoustic signals to a pair of left and right independent stereo speakers 2, 2 comprises input terminals 3L, 3R corresponding to left and right channels, respectively, operational output units 4L, 4R, a sound field adjustment filter 5, and delay circuits 6L, 6R. The digitized acoustic signals are inputted to the input terminals 3L, 3R. As an alternative, the acoustic signal processing device 1 is provided with a built-in AD converter, and is configured to convert the input analog signals into digital signals.

The sound field adjustment filter 5 is comprised of a pair of filter circuit groups 5L, 5R corresponding to the left and right channels, respectively. The one filter circuit group 5L generates a sound field adjustment signal from the acoustic signal inputted to the left channel input terminal 3L to output to the right channel operational output unit 4R. The operational output unit 4R adds the right channel sound acoustic signal passed through the delay circuit 6R and the sound field adjustment signal generated by the sound field adjustment filter 5L and outputs the result. Similarly, the other filter circuits 5R generates a sound field adjustment signal from the acoustic signal inputted to the right channel input terminal 3R to output to the left channel operational output unit 4L. The operational output unit 4L adds the left channel sound acoustic signal passed through the delay circuit 6L and the sound field adjustment signal generated by the sound field adjustment filter 5R and outputs the result. The delay circuits 6L, 6R add the delay time due to the formation of the sound field adjustment signals at the sound field adjustment filters 5L, 5R to the acoustic signals.

As shown in FIG. 2, each of the filter circuit groups 5L, 5R constituting the sound field adjustment filter 5 comprises a plurality of filter circuits 50a, 50b . . . 50n.

These filter circuits 50a, 50b . . . 50n comprise band pass filters 51a, 51b . . . and 51n for covering the desired frequency band in combination, delay setting means 52a, 52b . . . 52n for adding additional time delays τ1, τ2 . . . τn to the band pass filters 51a, 51b . . . 51n, respectively, and gain setting means 53a, 53b . . . 53n for adding a predetermined additional gains K1, K2 . . . Kn. The outputs of each of the frequency bands from the filter circuits 50a, 50b . . . 50n are combined, and the phase of the combined output is reversed by an inverter 54. Each impulse response of the filter circuit groups 5L, 5R is adjusted with respect to each frequency band of each of the band pass filters 51a, 51b . . . and 51n by means of the delay setting means 52a, 52b . . . 52n and the gain setting means 53a, 53b . . . 53n and thereafter summed, so that it is possible to configure a desired pass characteristic.

In this regard, FIR filters having the same impulse responses described above may be applied for the filter circuit groups 5L, 5R.

By the way, the good spatial spread feeling of the sound field reproduced by stereo speakers can be implemented by approximating to the interaural correlation coefficient at the listening position of the listener in the reverberant room (diffuse sound field) having regulated acoustic environment. However, with regard to the interaural correlation coefficient, in the case of the ordinary reproduced sound field wherein each of the left and right speakers is arranged at opening angle (direction angle θ_{OP} of each speaker around the listener) 60°, as shown in the triangular points in FIG. 9, the interaural correlation coefficient of the reproduced sound field is greatly different especially in comparison with that of the diffuse sound field (broken line in FIG. 9) in or above the middle range. Therefore, the frequency band is divided into narrow bands, and by individually adjusting the interaural correlation coefficient for each of the narrow bands, the interaural correlation coefficient of the diffuse sound field can be approximated (black dots in FIG. 9). To adjust this interaural correlation coefficient, the speaker position corresponding to the interaural correlation coefficient is virtually modified. As shown in FIG. 3, this position of the virtual speaker is expressed as a physical quantity, such as the opening angles θ_{OP} of a pair of speakers with respect to the listener.

The interaural correlation coefficient ρ_{d} of the diffuse sound field is represented by ρ_{d}=sin (kr)/kr.

where, k=ω/c=2πf/c, k: wavelength constant, c: sound velocity, and r: equivalent interaural distance 31.5 cm.

The interaural correlation coefficient ρₗᵣ at the listening position in a reproduced sound field of speakers is represented as follows.

$${ρ}_{lr} = \frac{2 A {A}^{′} {Φ}_{11} ( {τ}_{lr} ) + ( {A}^{′ 2} + {A}^{2} ) {Φ}_{12} ( 0 )}{( {A}^{2} + {A}^{′ 2} ) {Φ}_{11} ( 0 ) + 2 A {A}^{′} {Φ}_{12} ( {τ}_{lr} )} \qquad ( mathematical formula 1 )$$

where, A and A′: amplitude value, τₗᵣ: interaural time difference, Φ₁₁(τₗᵣ): autocorrelation function of the signal, Φ₁₂(τₗᵣ): cross-correlation function between the left and right signals.

Here, since the correlation coefficients between signals are uncorrelated, the term (A′²+A²)Φ₁₂(0)=0, and the term 2AA′Φ₁₂(τₗᵣ)=0 in the above equation, and accordingly, ρₗᵣ is determined by Φ₁₁(τₗᵣ), and the interaural time difference τₗᵣ is determined by the direction of the speaker.

The above estimate values almost coincide with the actual measured values, and the opening angles of the speaker with respect to the frequencies are such as shown in the Table of FIG. 4. Therefore, by dividing into the frequency bands where the frequency in the Table being the band median value thereof, followed by adjusting the speaker position at the corresponding opening angle, it is possible to adjust to the interaural correlation coefficient of the diffuse sound field.

On the premise of the above, the adjustment of the opening angle of the virtual speaker is controlled by the sound field adjustment filter. That is, the sound field adjustment filter 5 presets impulse responses of band-pass filters 51a, 51b . . . 51n for each of the divided frequency bands, the sound field adjustment signals are generated by passing the acoustic signals of right and left channels through these filters, and by adding the sound field adjustment signal in reverse phase with the acoustic signal of the other of the channels, it is possible to provide the sound field of the virtual speakers in which the opening angles thereof are changed with respect to the pair of stereo speakers fixed in position relative to the listener, so that the interaural correlation coefficient of the diffuse sound field can be approximated.

In the filter circuit groups 5L, 5R of the sound field adjustment filter 5, the desired impulse responses can be configured by adjusting the pass characteristic of each of the band-pass filter 51a, 51b . . . 51n for each band shown in FIG. 2 by means of the additional gain delay τ1 . . . τn of the time delay setting means 52a, 52b . . . 52n and the additional gain K1 . . . Kn of the gain setting means 53a, 53b . . . 53n, thereby it is possible to adjust the opening angle θ_{OP} of the virtual speaker 2′ such that the virtual speaker 2′ is located at the predetermined position on an arc which being centered on the listener P and having the distance from the listener P to the speaker 2 as a radius, as shown in FIG. 3. Accordingly, the good spread feeling can be achieved as the sound field reproduced by the speakers 2, 2 wraps around the listener, and it is possible to change not only the diffuse sound field but also the listening feeling of the listener in accordance with the preference.

FIG. 5 shows a sound processing apparatus according to another embodiment. In the following description, with regard to the same component in the above embodiment, the same reference number is used and the description thereof is omitted.

A sound field adjustment filter 9 in this sound processing device 8 is applied to a panel speaker 7 which is provided with a common diaphragm 7a. The sound field adjustment filter 9 comprises, in addition to a pair of filter circuit groups 5L, 5R, separation filters 10L, 10R and operational output units 11L, 11R corresponding to each channel. With regard to the acoustic signal, it is possible to set the additional time delay τ1 . . . τn and the additional gain K1 . . . Kn to the filter circuit groups 5L, 5R along the trend of change of the interaural correlation coefficient as in the previous embodiment in the mid-low frequency range band less than or equal to 1,000 Hz. However, in the mid-high range frequency band greater than or equal to 1,414 Hz, the interaural correlation coefficient tends to become negative, and the reverse phenomenon occurs so that the sound pressure level of the speaker of the channel of the other side each other to the left and right ears increases (region A in FIG. 7). The separation filters 10L, 10R comprise extraction filters 12L, 12R for isolating a particular frequency range A where the reversal phenomenon occurs among the acoustic signal and outputting to other channel, and transmission filters 13L, 13R for passing the frequency band where no reversal phenomenon occurs to its channel. The operational output units 11L, 11R combine the acoustic signal in the particular frequency area A separated by the separation filters 10R, 10L of other channel with the acoustic signal for its channel, respectively. Further, the filter circuit groups 5L, 5R generate sound field adjustment signals based on the acoustic signals outputted from the operational output units 11L, 11R. That is, the acoustic signal of a particular frequency area A separated by the extraction filters 12L, 12R of the separation filters 10L, 10R is synthesized in other channel, and the sound field adjustment signal is generated on the basis of this synthesized acoustic signal. Thereby the reversal phenomenon of the speaker 7 is avoided, and as in the previous embodiment, it is possible to approximate the interaural correlation coefficient of the diffuse sound field by adjusting the opening angle θ_{OP} of the virtual speaker 7′.

FIG. 6 shows a sound processing apparatus according to further embodiment. A sound field adjustment filter 15 in the sound processing apparatus 14 is applied to the panel speaker 7 which is provided with a common diaphragm 7a. The sound field adjustment filter 15 comprises reduction filters 16L, 16R corresponding to each of the channels in addition to a pair of filter circuit groups 5L, 5R. The reduction filters 16L, 16R reduce the level of only a particular frequency range A where reversal phenomenon occurs in the acoustic signals, and directly pass through the band except this frequency range. On the other hand, the filter circuit groups 5L, 5R are assigned a predetermined pass characteristics and further the level adjustment is performed so as to restore the acoustic signals in the frequency range A outputted to a low level. For example, the gain of the reduction filters 16L, 16R is set to k (0<k<1) for the acoustic signals in particular frequency range A where the reversal phenomenon occurs, and the additional gain in a particular frequency range A of the filter circuit groups 5L, 5R is set to reciprocal 1/k for recovering, to thereby generate the sound field adjustment signal. According to this, the reversal phenomenon of the speaker 14 is avoided, and as in the previous embodiment, it is possible to approximate the interaural correlation coefficient of the diffuse sound field by adjusting the opening angle θ_{OP} of the virtual speaker 7′.

### REFERENCE NUMBER MEANING

1 sound field adjustment apparatus
2 speaker
3L input terminal
3R input terminal
4L operational output unit
4R operational output unit
5 sound field adjustment filter
5L filter circuit group
5R filter circuit group
6L delay circuit
6R delay circuit
7 speaker
7a diaphragm
8 sound field adjustment device
9 sound field adjustment filter
10L separation filter
10R separation filter
11L operational output unit
11R operational output unit
12L extraction filter
12R extraction filter
13L transmission filter
13R transmission filter
14 sound field adjustment device
15 sound field adjustment filter
16L reduction filter
16R reduction filter
50a, 50b . . . 50n filter circuit
51a, 51b . . . 51n band pass filter
52a, 52b . . . 52n time delay setting means
53a, 53b . . . 53n gain setting means
54 inverter

1. A sound field adjustment filter for adding sound field adjustment signals for imparting desired sound field characteristics to acoustic signals outputted to a pair of speakers provided with a pair of left and right stereo channels comprising:
a pair of left and right filter circuit groups each including a plurality of filter circuits having particular pass characteristics;
said plurality of filter circuits receive said acoustic signals of both channels, divide a predetermined frequency band of the acoustic signals into a plurality of frequency bands, and individually adjust time delay and level of each divided frequency band, respectively,
wherein said plurality of filter circuits are synthesized to configure a desired impulse response in the entire frequency band of the acoustic signals so as to generate sound field adjustment signals corresponding to the left and right channels, and
wherein said pair of left and right filter circuit groups output said generated sound field adjustment signals to other channel with each other and
wherein by adjusting the pass characteristics for each of the divided frequency bands, a listener perceives virtual speakers whose opening angle between each other is changed with respect to said pair of speakers provided with the pair of channels and fixed in position, so that interaural correlation coefficients are approximated for perceiving a listening feeling in accordance with a preference.

2. The sound field adjustment filter according to claim 1,
wherein said pair of speakers is a panel speaker provided with a common diaphragm,
further comprising a left and right pair of separation filters for separating a particular frequency range where a reverse phenomenon that the sound pressure level outputted from one speaker of one of the channels based on the acoustic signal inputted to the one channel increases than the sound pressure level outputted from other speaker of other of the channels based on the acoustic signal inputted to the other channel occurs with regard to the mid-high frequency band of the acoustic signals so as to output to other channel, and
wherein said filter circuit groups generate the sound field adjustment signals based on the acoustic signals outputted from said pair of separation filters.

3. The sound field adjustment filter according to claim 1,
wherein said pair of speakers is a panel speaker provided with a common diaphragm,
further comprising reduction filters for reducing the level of a particular frequency range where the reverse phenomenon that the sound pressure level outputted from one speaker of one of the channels based on the acoustic signal inputted to the one channel increases than the sound pressure level outputted from other speaker of other of the channels based on the acoustic signal inputted to the other channel occurs with regard to the mid-high frequency range of the acoustic signals,
wherein said filter circuit groups are assigned such pass characteristics as to adjust the level to restore the frequency range outputted to a low level.

4. The sound field adjustment filter according to claim 1,
wherein each of said plurality of filter circuits constituting said filter circuit groups comprising:
a band-pass filter for dividing into a plurality of frequency bands so as to respectively adjust the pass characteristic;
time delay setting means for adding additional time delay of the divided frequency band; and
gain setting means for adding a predetermined additional gain of the divided frequency band.

5. The sound field adjustment filter according to claim 3,
wherein the additional gain of the particular frequency range in said reduction filters is set to the inverse of the gain of the particular frequency range in the filter circuit groups.

6. The sound field adjustment device using the sound field adjustment filter according to claim 1, comprising:
a delay circuit for adding a delay time required to generate the sound field adjustment signal to the acoustic signal; and
an operation output unit for adding the sound field adjustment signal to the acoustic signal so as to output to the stereo speaker side.

7. A sound field adjustment method for imparting desired sound field characteristics to acoustic signals outputted to a pair of speakers provided with a pair of left and right stereo channels comprising:
sound field generating step, provided with a plurality of filter circuits with particular pass characteristics which respectively receive said acoustic signals of both channels, divide a predetermined frequency band of the acoustic signals into a plurality of frequency bands and individually adjust time delay and level of each divided frequency band, said sound field generating step comprising synthesizing the filter circuits to configure desired impulse responses in the entire frequency bands of the acoustic signals so as to generate sound field adjustment signals corresponding to the left and right channels, outputting the generated sound field adjustment signals respectively to other channel with each other, and allowing a listener to perceive virtual speakers whose opening angle between each other is changed with respect to said pair of speakers to thereby approximating the interaural correlation coefficient for perceiving a listening feeling in accordance with a preference;
delaying step of adding delay time of said sound field generating process to the acoustic signals in the left and right channels; and
signal operation step of adding said sound field adjustment signals with time delay to said acoustic signals in the left and right channels.

8. The sound field adjustment method according to claim 7,
wherein said pair of speakers is a panel speaker provided with a common diaphragm, further comprising:
preliminary step of, before said sound field generating step, separating a particular frequency range where the reverse phenomenon that the sound pressure level outputted from one speaker of one of the channels based on the acoustic signal inputted to the one channel increases than the sound pressure level outputted from other speaker of other of the channels based on the acoustic signal inputted to the other channel occurs by a pair of right and left separation filter with regard to the mid-high frequency range of the acoustic signals so as to output to the other channel.

9. The sound field adjustment method according to claim 7,
wherein said pair of speakers is a panel speaker provided with a common diaphragm, and further comprising:
preliminary step of, before said sound field generating step, reducing the level of a particular frequency range where the reverse phenomenon that the sound pressure level outputted from one speaker of one of the channels based on the acoustic signal inputted to the one channel increases than the sound pressure level outputted from other speaker of other of the channels based on the acoustic signal inputted to the other channel occurs by a reduction filter with regard to the mid-high frequency range of the acoustic signal, and
wherein, in said sound field generating step, the pass characteristics are assigned such that the level is adjusted so as to restore the frequency range outputted in a low level.
